(19) United States
(12) Patent Application Publication
(10) Pub. No.: US 2010/0301746 A1
(43) Pub. Date: Dec. 2, 2010

(54) GAS DISCHARGE LAMP WITH A GAS FILLING COMPRISING CHALCOGEN

(75) Inventors: Achim G.R. Koerber, Kerkrade (NL); Johannes Baier, Wuerselen (DE); Robert P. Scholl, Roetgen (DE); Daiyu Hayashi, Aachen (DE); Stefan Schwan, Herzogenrath (DE); Rainer Hilbig, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,323

(22) PCT Filed: May 6, 2008
(86) PCT No.: PCT/IB2008/051752

§ 371 Date: Nov. 9, 2009

(30) Foreign Application Priority Data
May 10, 2007 (EP) 07107931.3

(51) Int. Cl. H01J 61/06

(52) U.S. Cl. 313/633

(57) ABSTRACT

A gas discharge lamp (1) equipped with a gas discharge vessel (2) enclosing a gas filling, said gas filling comprising a chalcogen selected from the group of sulfur, selenium or tellurium or a compound thereof, and with means for igniting and maintaining a gas discharge, comprising an electrode assembly (6-9) disposed in the discharge vessel, the electron-emissive material (9) of the electrode assembly comprising iridium or an alloy of iridium, providing a long-lived, efficient, compact, and high intensity white light source for applications such as general and professional illumination.

### TECHNICAL FIELD OF THE INVENTION

The invention relates to a gas discharge lamp, particularly a high pressure gas discharge lamp, equipped with a gas discharge vessel enclosing a gas filling, said gas filling comprising a chalcogen selected from the group of sulfur, selenium or tellurium or a compound thereof, and with means for igniting and maintaining a gas discharge comprising an electrode assembly.

### BACKGROUND OF THE INVENTION

Because of their good lighting properties, high-pressure gas discharge lamps have become widely popular. These lamps generally comprise a discharge vessel and two electrode assemblies, each electrode assembly comprising an electrode extending into the discharge space enclosed by the discharge vessel. When the lamp is in the operating state, an arc discharge is ignited between the free ends of the electrodes.

The discharge vessel generally contains a gas filling comprising a starter gas, such as, for example, argon, a discharge gas, such as, for example, one or more metal halides, such as sodium iodide and/or scandium iodide, which forms the actual light-emitting material, as well as mercury as a buffer gas, whose principal function is to promote the evaporation of the light-emitting substances by raising the temperature or pressure and to increase the efficacy and burning voltage of the lamp.

However, mercury is a highly toxic and environmentally hazardous substance. Wherever possible, it is no longer used at all or only to a reduced extent, as its use, production and disposal represent a threat to the environment. Since people's awareness to environmental issues is increasing steadily, the market asks for lamps with a reduced mercury content. This creates opportunities for new products.

Among these new products are gas discharge lamps comprising sulfur or a sulfur-containing compound in their gas filling, which are generally known as “sulfur lamps”.

Sulfur lamps usually contain no mercury at all. A sulfur lamp consists of a spherical quartz envelope filled with a few milligrams of sulfur and an inert noble gas, such as argon. When heated up to a gaseous state, sulfur forms diatomic sulfur molecules, or dimers. The dimers emit a broad continuum of energy as they drop back to lower energy states—a process called molecular emission. Molecular sulfur emits over almost the entire visible portion of the electromagnetic spectrum, producing a uniform visible spectrum similar to sunlight but with very little undesirable infrared or ultraviolet radiation. As much as 73% of the emitted radiation is in the visible spectrum, far more than in other types of lamps. The visible light output mimics sunlight better than any other artificial light source, and the lack of harmful ultraviolet radiation can be especially beneficial to museums.

However, there are some difficulties associated with sulfur as a lamp filling. One of the major difficulties is its chemical reactivity with common electrode materials, such as tungsten.

From U.S. Pat. No. 5,404,076 an arc lamp is known, comprising an envelope of light transmissive material, which includes electrodes, a fill in said envelope in which elemental sulfur is the primary radiating component, the fill having a pressure of at least about 1 atmosphere at operating temperature, and excitation means for applying a voltage to said electrodes for coupling energy to said fill. The electrodes are made of or plated with a special material, such as platinum, to prevent chemical reactions with the fill gas, which may lead to electrode deterioration.

In spite of this disclosure, it is generally assumed that it is not possible to maintain a sulfur discharge using platinum electrodes, as the melting point of platinum at 2042.1 K is too low for an electrode material useful for sulfur lamps. Consequently, in the current implementations, an electrodeless discharge design is chosen to avoid this problem.

Unlike arc discharge lamps, electrodeless lamps do not rely on electrodes, but rather produce light by creating a plasma discharge in a gas contained in a bulb by exposing the lamp gas to intense microwave or radio-frequency radiation.

The excitation of the sulfur lamp requires a microwave generator. Thus, a separate mechanism to couple the microwave radiation to the bulb is required. The need for such a separate coupling mechanism is a problem with the electrodeless sulfur lamp because inefficiency of the coupling and the microwave generator correspondingly constrains the overall efficiency of the electrodeless sulfur lamp. In practice, this approach may lead to a total power loss as high as 40% because of coupling inefficiencies. In addition, the resulting structure is not physically compact, because the RF-structure is separate from the bulb.

Sulfur lamps also have a quirk having to do with convection. The bulbs need to be rotated continuously to distribute the sulfur/Ar mixture, so there is also a motor involved. In the absence of bulb rotation, an isolated or filamentary discharge results, which does not substantially fill the inside of the bulb.

The requirement of rotation introduces certain complications. If the bulb has to be rotated by a motor, this has the potential of failure, and may be a limiting factor on the lifetime of the lamp. Furthermore, additional components are necessary, thereby making the lamp more complex and requiring the stocking of more spare parts.

### SUMMARY

It is an object of the current invention to provide improved light sources that avoid these and other problems that occur with known sulfur light sources, and it is to these ends that the present invention is directed.

The object is achieved by a gas discharge lamp equipped with a gas discharge vessel enclosing a gas filling, said gas filling comprising a chalcogen selected from the group of sulfur, selenium or tellurium or a compound thereof, and further comprising an electrode assembly disposed in the discharge vessel, the electron-emissive material of the electrode comprising iridium or an alloy of iridium.

Contrary to the indicated expectations, it has been found that a material comprising iridium or an iridium alloy in a properly designed electrode assembly operates extremely satisfactorily in a chalcogen discharge. By using iridium or an iridium alloy as electron emissive material, chemical reactions with the chalcogen in the gas filling are avoided. Thus, efficiency, life expectancy and maintenance of such lamps are very good.

Preferably, the alloy of iridium is selected from the group of ruthenium:iridium alloys, osmium:iridium alloys, rhodium:iridium alloys, palladium:iridium alloys or platinum:iridium alloys, having a composition with less than 100% and more than

80% iridium. Pure iridium is a brittle and hard material, especially in an annealed state, which hinders electrode processing. Alloying the iridium material with e.g. ruthenium, osmium, rhodium, palladium or platinum increases the ductility of the obtained material, which is advantageous for electrode processing, e.g. wire drawing and electrode shaping (such as grinding, welding), and also for the mechanical strength of the electrode in operation. It should be noted that the melting point of such a material is still high enough for an electrode material for use in a chalcogen discharge.

In a preferred embodiment of the lamp according to the invention, the electrode comprises a rod and a head attached to said rod.

Alternatively, the electrode may comprise a rod and a coil wound around said rod. This structure of the electrode provides an adequate heat distribution on the electrode.

The electron-emissive material may be formed as a solid body or alternatively as a coating.

Preferably, the electrode assembly comprises also a feedthrough. Conventional lamp components typically comprise molybdenum or molybdenum alloys for feedthroughs for quartz discharge vessels or niobium or niobium alloys for ceramic discharge vessels. However, these feedthrough materials as such do not provide a sufficient corrosion resistance for adequate protection against the chalcogen lamp atmosphere. Thus, in an embodiment of the invention, the lamp component comprises a feedthrough composed of a material selected from the group of iridium or iridium alloys.

With regard to the gas filling according to an embodiment of the invention, the compound comprising selenium or tellurium is preferably selected from the group of the selenium tetrahalides SeCl₄, SeBr₄ SeI₄ or of the tellurium tetrahalides TeCl₄, TeBr₄ or TeI₄.

Preferably, the total molar elemental concentration of the chalcogen or the compound thereof is between 1E-11 and 1E-04 mol/cc.

The gas filling may further comprise a metal selected from the group of tin and germanium.

The gas filling may additionally comprise a metal halide. The color-rendering index (CRI) of the discharge lamp is significantly improved by adding a metal halide to the fill, particularly a metal halide selected from the group of halides of titanium, zirconium, hafnium, vanadium, niobium, tantalum, chromium, molybdenum, tungsten or mercury or mixtures thereof. The high energy efficiency and brightness of such lamps, but also their high CRI (Color Rendering Index) puts them on par with sunlight ar regards quality of illumination—minus a greatly reduced component of damaging ultraviolet light.

Preferably, the total molar elemental concentration of the chalcogen or the compound thereof, the metal and the halogen is between 1E-11 and 1E-04 mol/cc.

### BRIEF DESCRIPTION OF THE DRAWINGS

In the drawings:

FIG. 1 is a cross-sectional view of a gas discharge lamp according to an embodiment of the present invention;

FIG. 2 is a cross-sectional view of a gas discharge lamp according to another embodiment of the present invention;

FIG. 3 shows a computer simulation of the molecular and continuum emission spectrum of a first lamp according to the invention;

FIG. 4 shows measurement results of the emission spectrum of the first lamp according to the invention;

FIG. 5 shows measurement results of the emission spectrum of a second lamp according to the invention.

### DETAILED DESCRIPTION OF THE INVENTION

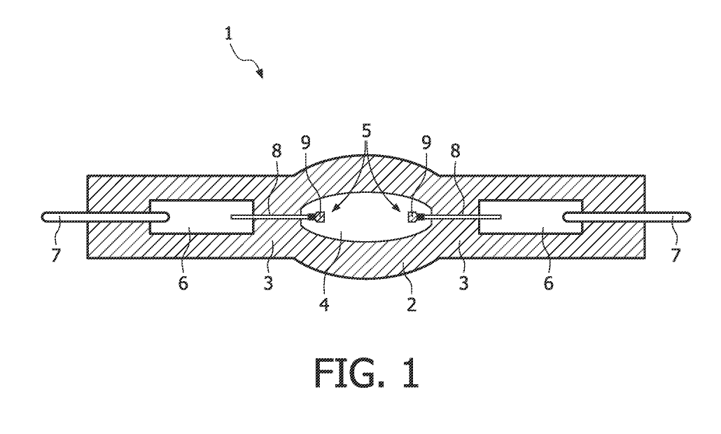

FIG. 1 diagrammatically shows the construction of an embodiment of a lamp according to the invention. The lamp shown in FIG. 1 is an AC-lamp, but DC-lamps also fall within the scope of the present invention.

The lamp 1 has a light-transmitting discharge vessel 2, which has opposite seals 3 and encloses a discharge space 4. The discharge vessel is preferably made from quartz or another suitable material, such as a polycrystalline ceramic material of yttrium aluminum garnet, ytterbium aluminum garnet, micro-grain polycrystalline alumina, polycrystalline alumina, sapphire, or yttria.

It should be mentioned that the shape of the discharge vessel may be a design element in the lamp design. As shown in FIG. 1, the shape of the lamp is preferably elongated and comprises two cylindrical sections as the neck portions and, arranged therebetween, a generally substantially ellipsoid-shaped discharge vessel 4. Alternatively, the invention may be utilized with discharge vessels of different shapes, e.g., having a substantially spherical, cylindrical, oblate spheroid, ovoidal, etc. portion in the centre.

Typically, the lamp comprises two electrode assemblies, each comprising the electrode itself and a feedthrough. Typically, each electrode comprises a front portion and a rear portion, formed as an electrode head and an electrode rod. The feedthrough, through which the electrode extends into the discharge space enclosed by the discharge vessel, comprises a feedthrough part and lead-in wires. When the lamp is in the operating state, an arc discharge is ignited between the electrode heads.

The electrodes project into the interior of the discharge vessel 4, where they are arranged at a distance d from each other.

In one embodiment, as illustrated in FIG. 1, the electrodes are composed of a rod and a coil attached to its end. Disposed at the other end of the rod extending outside of the discharge space are feedthroughs and lead-in wires, which, during operation, are connected to a current source.

In the embodiment of FIG. 1, each current feedthrough is composed of a metal foil 6, which is fully located inside a respective seal 3, and of a lead-in wire 7, which projects from the discharge vessel 1.

The feedthroughs are embedded in the respective neck regions of the discharge vessel. To ensure a vacuumtight closure of the locations of the discharge vessel where the electrode assembly projects into the discharge space, the neck regions of the discharge vessel are formed by locally pinching together the ends of the body, which was initially formed as a glass tube. These regions 3 are accordingly denoted “pinches”.

The process of hermetically sealing the electrode assembly into the discharge vessel is advantageously a shrink seal method in which the inside of, for example, a silica glass tube, which has a discharge vessel part and sealing parts, is exposed to a negative pressure. The outer periphery of the respective sealing part of this silica glass tube, in this state, is heated by means of a torch or the like. The diameter of the silica glass comprising the envelope of this sealing part is reduced by softening. In this way, hermetically sealed parts are formed.

Otherwise, in order to seal the electrodes into the envelope, the glass is warmed up at the end in which the electrode is disposed and when soft, a press-seal is made.

When the seal is made, the electrode assembly is rigidly disposed in the envelope. A similar electrode assembly is disposed at the other end of the silica glass tube and then sealed in a manner such as described above.

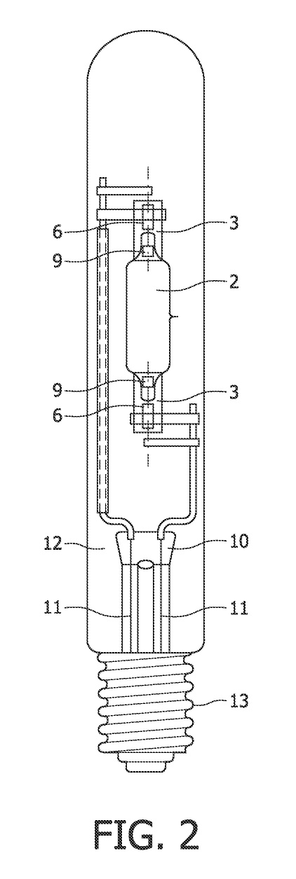

FIG. 2 diagrammatically shows a possible alternative embodiment of a gas discharge lamp, which can be operated with the electrodes according to the invention.

Again, the lamp comprises a quartz glass discharge vessel 2, in which a chalcogen or a compound comprising a chalcogen as the discharge gas is present and iridium-comprising electrodes are provided for igniting a discharge. The current is supplied through current supplying feedthrough parts, which are passed through respective pinches 3 at mutually opposed ends of the discharge vessel 2 and are connected to the iridium-comprising electrodes.

The lamp 1 is surrounded by an outer envelope 12, which has a vacuumtight pinch 10 at one end through which the connection terminals 11 extend. These wires connect the electrodes to a conventional screw base 13 at the outer envelope 12 via metal straps welded to the outer electrodes. Additionally the discharge vessel 2 is supported within the outer envelope 12 by means of metal band members at the ends of the lamp 1 surrounding a dimple in each end of the lamp.

The coolest regions of the discharge vessel during operation are the ends, and to insure that they do not drop below a desired temperature, an infrared-reflective coating, which reflects incident infrared radiation, may be applied to the ends and to the adjacent portions of the pinch seals. In addition, as a heat conservation measure, the space between inner and outer envelope, the inter-envelope space, may be evacuated. In the larger sizes of lamps such evacuation is not necessary.

The fill in discharge space 4 generally comprises, first of all, a discharge gas. This substance is present as the primary radiating component of the bulb fill.

In the lamp according to the invention, the discharge gas includes elemental sulfur, selenium or tellurium, or an appropriate sulfur, selenium or tellurium compound. For example, selenium tetrahalides SeCl₄, SeBr₄ SeI₄ or tellurium tetrahalides TeCl₄, TeBr₄ or TeI₄ may be used.

In addition to the discharge gas, certain quantities of inert gases are usually introduced into the discharge space 4, which enhance the ignition and the start of the discharge process. For example, a small amount of argon and/or xenon may be used for this purpose. Helium, neon, krypton and xenon or combinations thereof may also be used.

By further adding a metal selected from the group of tin and germanium, the operating characteristics are very positively influenced as regards (re-)ignition behavior, stability of the discharge, and lamp life.

It is also desirable to add a component to the fill that might improve color rendition.

Sulfur lamps without color-improving additives are a bit greenish compared to a blackbody source. Thus, the illumination provided by the lamp may be augmented in various regions of the spectrum by including certain additives in the fill.

For example, such additives, which can be used to emphasize different areas of the spectrum, may include metal halides, selected from the group of halides of titanium, zirconium, hafnium, vanadium, niobium, tantalum, chromium, molybdenum, tungsten or mercury or mixtures thereof.

It is additionally proposed that the gas filling is free from mercury. Yet, in certain implementations, the addition of some mercury may improve operation by reducing the restrike time of the lamp. While one advantage of the invention is that it provides a lamp which is capable of operating without using mercury, the addition of a small amount of mercury may help lamp starting and stabilizing the discharge. Additionally, for those applications where the presence of mercury is not considered to be a problem, it has been found that the addition of more substantial amounts of mercury increases efficiency significantly.

It should be further understood that the absolute amount of the primary fill component in solid form which is used in the bulb may vary depending on which substance is used, e.g., sulfur, selenium, tellurium or compounds thereof, and depending on the type of discharge lamp, e.g. discharge lamp, low pressure discharge lamp or dielectric barrier discharge lamp. Anyway, the sum of the molar concentrations, calculated for the respective elements, will always be between 1E-11 and 1E-04 mol per cubic centimeter (cc),

Similarly, in embodiments where transition metals and halides are added to the chalcogen, the sum of the molar concentrations of the halogen, the transition metal and the chalcogen, calculated for the element, is preferably between 1E-11 and 1E-04 mol/cc in the gas discharge vessel.

The design of an electrode assembly of a discharge lamp according to the invention is quite similar to that generally used in the art. Typically, the electrode assembly is composed of a lead-in wire 7 for external contact, a feedthrough 6 and an electrode 8,9. The second electrode assembly is similarly constructed.

The electrodes may be of any of the typical designs. According to one embodiment of the invention, the electrode consists of a head part and a rod part. These may be made of different materials. Alternatively or additionally, the head and rod parts may also have different diameters.

According to one embodiment of the invention, the electrode head is a solid body and has a substantially circular cross-section. The head and rod parts of the electrode may be made from the same material in the case of different diameters. The electrode may then be manufactured in one piece, the portions of different diameter being formed, for example, by grinding or etching.

In a further embodiment of the invention, the design of the electrode comprises a rod coated with iridium or an iridium alloy, surrounded at its inner end by a helical coil of iridium or a material comprising iridium.

As said hereinabove, according to the invention, the electron-emissive material of the electrode is formed of a material comprising iridium or an iridium alloy.

Iridium, a noble metal, is more resistant to oxidation and other forms of chemical attack than the known electrode materials, particularly the refractory metals tungsten and molybdenum. Thus, the electrode will not easily burn out if exposed to the aggressive atmosphere of lamps comprising sulfur, selenium, tellurium or compounds thereof.

Notable properties of iridium are its melting point at 2446±3° C., considerably higher than platinum, its electrical resistivity at 0° C. of 4.71 microohm.cm, a thermionic emission work function at 5.5 eV and a thermal conductivity of 1.48 W/cm.

The melting temperature of 2446° C. is exceeded only by that of the refractory group metals. Thus, it can be used unprotected in aggressive atmospheres at temperatures exceeding 2000° C. as a thermionic source of electrons. Even at these temperatures, iridium shows outstanding resistance to sulfur, selenium or tellurium or a compound thereof.

It is to be noted that iridium of standard purity comprises at least 99.8% of iridium. Pure iridium is a brittle and hard material, which is difficult to work mechanically, especially in an annealed state, which hinders electrode processing. Alloying the iridium material increases the ductility of the obtained alloy, which is advantageous for electrode processing, e.g. wire drawing, electrode shaping, such as grinding and welding, and assembling, and also for the mechanical strength of the electrode in operation.

Iridium is therefore preferably alloyed with another metal of the platinum group, which is selected from ruthenium, osmium, rhodium, palladium and/or platinum, selected from the group of ruthenium:iridium alloys, osmium:iridium alloys, rhodium:iridium alloys, palladium:iridium alloys or platinum:iridium alloys.

Preferably, the alloy comprises at least 0.01% by weight of the platinum group component, which is selected from ruthenium, osmium, rhodium, palladium and/or platinum and at least 80% by weight of iridium to provide a material with an adequate melting point. Advantageous examples include 5%, 10% or 15% by weight of the platinum group component.

The alloys disclosed here should be understood such that only the components that are dominant in determining the respective properties are indicated. Further elements may be present in small concentrations of, for example, less than 1%, without this being separately noted.

Furthermore, it should be noted that the electrode may comprise small quantities of unavoidable impurities or additives, such as oxygen, carbon and nitrogen introduced e.g. as a result of metallurgical processing during the manufacture. The quantity of oxygen, carbon and/or nitrogen is not taken into account in the definitions of the quantities of the alloy constituents for use in the electrode.

In the preferred embodiment, the inner electrodes are fabricated from a single piece of iridium and shaped by standard grinding techniques, using well-known hard abrasives including aluminum oxide, diamond, and cubic boron nitride to form the inner electrode head and rod. Laser ablation may also be used to machine the electrode head.

Sintering of powder-formed bodies is another fabrication approach, but may require additional compacting steps, such as hot isostatic pressing (HIP), to achieve sufficiently high densities for microstructural stability.

However, the electron-emissive material is not necessarily provided as a solid body. It may alternatively be employed as a coating over a substrate to form the electrode.

The substrate is useful primarily to provide support for the electron-emissive material and therefore can be an electroconductive material, but also a non-conductive or semi-conductive material.

Nevertheless, the substrate should be of a material which is resistant to the environment in which it is used. The substrate may be, for example, a valve metal.

Particularly the material of the electrode rod may be a valve metal substrate coated with iridium or an iridium alloy, as the requirement set for the electrode rod is less demanding and its operation temperature is lower. The term “valve metals”, as applied to electrode materials, is defined as being high melting, corrosion resistant, electrically conductive metals which passivate, i.e., form protective films in certain corrosive environments, for example, titanium, tantalum, niobium, zirconium, hafnium, molybdenum, tungsten, aluminum and alloys thereof. Tungsten is a preferred substrate material because of its electrical and chemical properties, its availability, and its cost relative to other materials with comparable properties.

The coatings can be prepared by any of the standard techniques. Thus, any physical or chemical method, such as evaporation, chemical and/or physical decomposition, ion-clustering, electron-beam or sputtering process can be utilized. The coating can be in powder or thin-film form.

Coating thicknesses are not crucial and may range broadly, for example, up to about 100 microns although a preferred thickness is less than 10 microns. Other thicknesses are not necessarily precluded so long as they are practical for their intended use.

As will be appreciated, the desired thickness is somewhat dependent upon the process of preparation of the electrode and somewhat upon the intended use. Thus, an electrode can be prepared by pressing the electron-emissive material in powder form into a predetermined shape and can be thick enough to be self-supporting. If a sputtering process is employed, relatively thin layers can be deposited, and these are preferably supported by a suitable substrate, as noted hereinabove. Thus, it is to be understood that the actual electron emissive material of the present invention is iridium or an iridium alloy, whether supported or unsupported.

In certain embodiments of the discharge lamp according to the invention, it is desirable to select the feedthrough material also from the group of iridium or iridium alloys.

Like the material of the electrode it may be employed as a solid body or as a coating on the conventional feedthrough part.

In the operational state of the lamp, an arc discharge (light arc) is ignited between the tips of the electrodes. The lamp according to the invention is intended to be operated with an electronic ballast, a magnetic ballast, or other convenient ballast. The ballast must be capable of supplying electrical power at a sufficient voltage and current to break down the fill gas for arc discharge and provide a high enough open-circuit voltage to maintain a glow discharge during start-up. The ballast should also apply a fixed or regulated rms current during steady-state operation to run the lamp at the desired power. The waveform may be direct-current (DC) or alternating-current (AC) or the various known variations thereof. The exact AC waveform shape is not believed to be critical to the electrode operation; however, square-wave operation in particular may have certain advantages over sine-wave operation with respect to arc attachment and maintenance. DC operation may have even further advantages in some applications.

### SPECIFIC EMBODIMENTS OF THE INVENTION

By way of example, and not limitation, a gas discharge lamp with a gas filling comprising chalcogen may be constructed in accordance with the following specifications.

A quartz discharge vessel in the form of a rotational ellipsoid, as shown in FIG. 1, with an outer diameter of 15 mm, an outer length of 18 mm and a wall thickness of 2 mm is equipped with iridium electrodes, disposed at a separation distance of 14 to 16 mm.

The iridium rod electrodes are of 1000 μm diameter, and are welded to a conventional molybdenum foil/quartz feedthrough.

As a gas filling, various chalcogen-comprising mixtures may be used.

According to a first embodiment, the chalcogen-comprising mixture comprises 1.5 mg sulfur, 10.0 mg mercury and 0.13 mg mercury (II) chloride. As a starting gas, 4 μmol argon is also included.

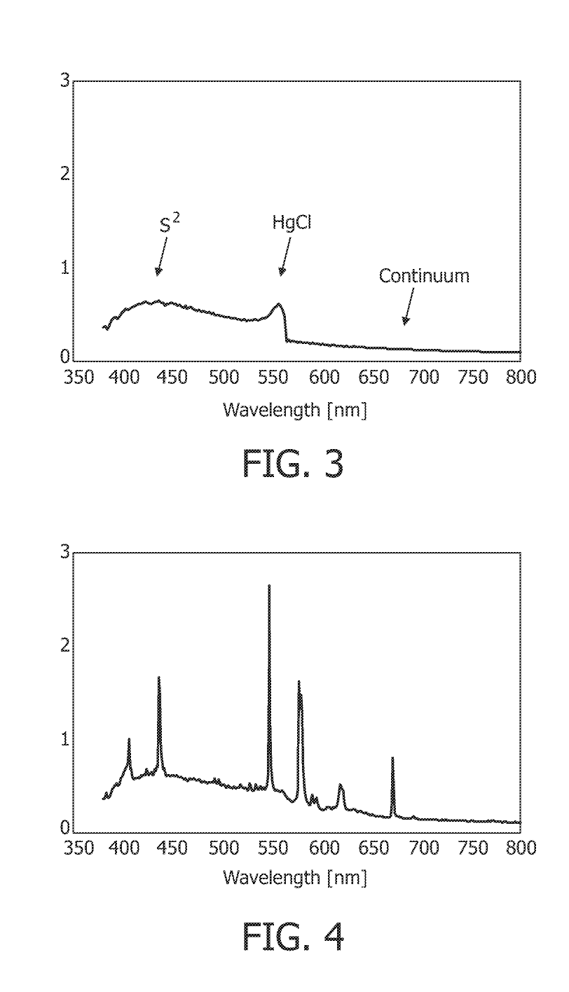

In this embodiment, the lamp is supplied with an operating voltage of 218 V at a power of 361 W, resulting in a lamp current of approximately 2.56 A. In FIG. 4 of the drawing, the spectral output of the lamp according to this embodiment is represented. This spectrum shows the emission lines of mercury, but also a marked visible continuum, which can be interpreted in the blue spectral range as emission of the S₂ B ³Σᵤ⁻-X ³Σ_{g} band system and in the green spectral range as emission of the HgCl B ²Σ⁺-X ²Σ⁺ band system (see FIG. 3). Especially the fact that below ˜400 nm the band structure of the S2 B-X system is visible in absorption demonstrates that the outer, colder gas zone of the operating lamp contains a high partial pressure (>1bar) of S₂ molecules. This proves that the iridium electrodes do not react with the gaseous sulfur of the lamp filling.

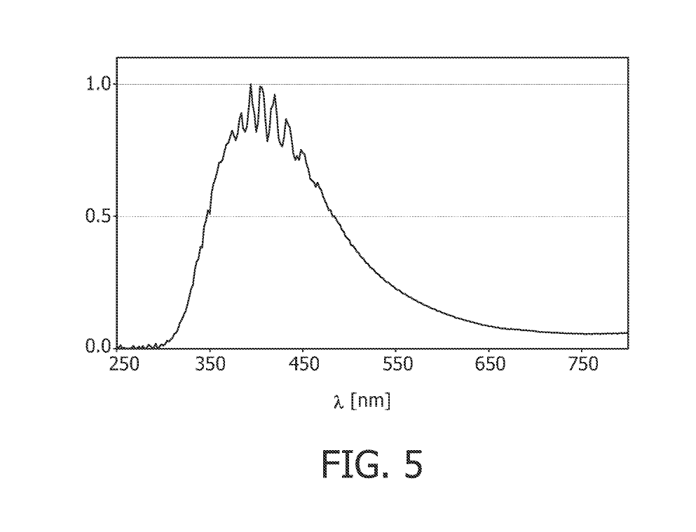

In a second embodiment, the two electrode heads are of 2000 μm diameter, which reduce to rods of 600 μm diameter, which in turn are welded to conventional molybdenum foil/quartz feedthroughs. The lamp filling contains 0.8 mg sulfur and 4 μmol of argon. The lamp has been operated at 90 W input power at a frequency of 27.12 MHz and emitted the spectrum shown in FIG. 5.

Throughout this description, embodiments and variations are described for the purpose of illustrating uses and implementations of the invention. The illustrative description should be understood as presenting examples of the invention, rather than limiting the scope of the invention.

1. A gas discharge lamp (1) equipped with a gas discharge vessel (2) enclosing a gas filling, said gas filling comprising a chalcogen selected from the group of sulfur, selenium or tellurium or a compound thereof, and further comprising an electrode assembly (6,7,8,9) disposed in the discharge vessel, wherein the electron-emissive material of the electrode assembly comprises iridium or an alloy of iridium.

2. A gas discharge lamp according to claim 1, wherein the alloy of iridium is selected from the group of ruthenium:iridium alloys, osmium:iridium alloys, rhodium:iridium alloys, palladium:iridium alloys or platinum:iridium alloys, having a composition with less than 100% and more than 80% iridium.

3. A gas discharge lamp according to claim 1, wherein the electrode assembly comprises a rod (8) and a head (9) attached to said rod.

4. A gas discharge lamp according to claim 1, wherein the electrode assembly comprises a rod (8) and a coil (9) wound around said rod.

5. A gas discharge lamp according to claim 1, wherein the electron-emissive material is formed as a solid body.

6. A gas discharge lamp according to claim 1, wherein the electron-emissive material is formed as a coating.

7. A gas discharge lamp according to claim 1, wherein the electrode assembly comprises a feedthrough (6), and the material of the feedthrough is also selected from the group of iridium or iridium alloys.

8. A gas discharge lamp according to claim 1, wherein the compound comprising selenium or tellurium is selected from the group of selenium tetrahalides SeCl₄, SeBr₄ or SeI₄ or tellurium tetrahalides TeCl₄, TeBr₄ or TeI₄.

9. A gas discharge lamp according to claim 1, wherein the total molar elemental concentration of the chalcogen or the compound thereof is between 1E-11 and 1E-04 mol/cc.

10. A gas discharge lamp according to claim 1, wherein the gas filling further comprises a metal selected from the group of tin and germanium.

11. A gas discharge lamp according to claim 1, wherein the gas filling further comprises a metal halide.

12. A gas discharge lamp according to claim 11, wherein the metal halide is selected from the group of halides of titanium, zirconium, hafnium, vanadium, niobium, tantalum, chromium, molybdenum, tungsten or mercury, or mixtures thereof.

13. A gas discharge lamp according to claim 11, wherein the total molar elemental concentration of the chalcogen or the compound thereof, the metal and the halogen is between 1E-11 and 1E-04 mol/cc.
